(19) United States
(12) Patent Application Publication
(10) Pub. No.: US 2004/0001737 A1
(43) Pub. Date: Jan. 1, 2004

(54) Pen with multiple writing elements

(76) Inventor: Betsy L. Giron, Lombard, IL (US)

Correspondence Address: Jerry A. Schulman, Court C, One South 376 Summit Avenue, Oakbrook Terrace, IL, 60181, US

(21) Appl. No.: 10/183,246

(22) Filed: Jun. 27, 2002

(51) Int. Cl. B43K 27/08

(52) U.S. Cl. 401/35; 401/34

(57) ABSTRACT

A writing instrument has multiple writing inserts to enable a user to write with more than one color. The inserts are mounted into a body having a generally oblong cross-section with at least two tips extending from one end of the body. The body dimensions create a pair of flat, opposed gripping surfaces which enable the user to index the movement from one tip to the other using only one hand and no moving parts, while positioning the tips a far enough distance apart to ensure that only one tip at a time contacts the writing surface.

### BACKGROUND OF THE INVENTION

The present invention relates generally to writing instruments and, more particularly, to a pen having two separate writing tips accessible with the use of only one hand.

Writing instruments having multiple writing mechanisms are well-known in the art. The uses to which those writing instruments are put range from the artistic and whimsical, such as pens and pencils reconfigurable to allow the use of leads or ink cartridges of varying colors to scientific and precise data-recording instruments used when particular data must be recorded in different colors.

One example of a more serious of such uses is the recording of information or notes by a nurse, doctor or dentist. As an example, general notes may be transcribed in blue or black, while medical alerts or particularly important information may be recorded in red. Providing two colors in a single writing instrument makes this task convenient: allowing the change from one color to the other using one hand without mechanical expedients makes the task much easier.

The ease with which this writing instrument can be accurately manipulated to change the writing color can also be helpful to teachers who may mark the correct answers in blue and the incorrect answers in red.

During a lecture students who wish to color code their notes can quickly write down the information as it is presented. Where it would be cumbersome and distracting for the student to use both hands to change the color on a more conventional pen, use of the present invention allows the student to change color in a fraction of the time that is would take with other multicolor writing instruments.

The present invention finds particular utility for those who have temporarily or permanently lost the use of one hand. The oblong cross-sectional configuration allows the user to change from one color to the other: the rounded edges of the oblong shape allows the writing instrument to be quickly flipped to switch from one writing point to the other. Other multicolor writing instruments tend to have a round cross sectional shape which lacks a guide plane to assure the user that the color change has taken place.

Variations on the principal function of providing a pen with the capability of writing in more than one color are shown in a number of prior issued patents. Throughout, when the term “pencil points” is used, it will refer to a length of the commonly-provided writing medium in a pencil, namely, a graphite shaft or “lead.”

U.S. Pat. No. Des. 422,308 (Chuang) teaches and describes an ornamental design for a building block type writing implement assembled from a number of individual blocks with each such block holding a pair of what appears to be pencil points. As seen in FIG. 8 of Chuang, a plurality of such blocks are assembled into a writing instrument with a generally rectangular cross-section having sharp edges. Because Chuang is a design patent, it includes no teaching as to the utility or use of such an instrument and it appears that the size and the sharpness of the edges would make it more difficult to maneuver with one hand.

U.S. Pat. No. Des. 312,658 (Sumino) teaches and describes an ornamental design for a combined twin-nibbed ball point pen and marking pen constructed essentially as two cylindrical writing instruments having different writing tips at each end with the two instruments joined by a central web. The cross-sectional configuration of this design is shown in FIG. 5 of Sumino and it appears that the user of such an instrument would grasp the instrument around the periphery of one such barrel and hold it at such an angle in his or her hand as to bring the desired point into contact with the writing surface.

U.S. Pat. No. 5,791,798 (Yu) teaches and describes a multi-purpose writing instrument assembled from individual blocks assemblable into a single-barrel writing instrument. FIG. 1 of Yu shows a block-type dual point construction which appears to be similar to that shown in Chuang but which is otherwise unidentified.

U.S. Pat. No. 2,449,939 (Heyberger) teaches and describes a writing instrument having a pair of ball point pen refills mounted to a round cylindrical barrel or pen body. As seen in FIG. 4 of Heyberger, the two pen points are angled with respect to each other and in order to accomplish this angling, the refills must be bent as they are mounted in the pen barrel. It also appears that the instrument shown in Heyberger must be angled when held by a user in order to bring the selected pen point into an effective position for writing and the round shape of the barrel provides no tactile index to determine when the change from one color to another has been done.

U.S. Pat. No. 365,011 (Ludington) teaches and describes a pen holder which shows a forked holder body capable of holding two pen nibs. The holder body is substantially circular in cross-section and the nibs are arranged so that the pen holder must be rotated about 180 degrees to bring the second nib into position for writing after the first nib has been used.

U.S. Pat. No. 6,315,477 (Kuhn et al) teaches and describes a writing device with at least two writing elements, one of which is a pencil element and which also includes a mechanical arrangement for moving at least one of the writing points into the barrel or outward from the barrel when that point is desired to be used.

U.S. Pat. No. 5,044,804 (Chuang) teaches and describes a writing instrument assemblable from individual blocks. The blocks appear to be somewhat similar to the blocks shown in the Chuang design U.S. Pat. No. Des. 422,308. FIG. 8 of the Chuang '804 reference shows three writing points assembled in side-by-side fashion and the accompanying description makes it clear that such arrangement is intended to allow multiple parallel lines to be drawn with a single instrument.

U.S. Pat. No. Des. 273,395 (Wilkinson) teaches and describes an ornamental design for a multiple point ball point pen which appears to include five writing elements used to simultaneously draw five parallel lines for use in transcribing music.

U.S. Pat. No. Des. 403,355 (Fillion) teaches and describes a multi-headed writing instrument having four separate writing elements each spaced 90 degrees from each other.

U.S. Pat. No. 4,030,841 (Balasty) teaches and describes a triangular holder and instrument showing a triangular pencil holder which is applied to a standard pencil and which provides a triangular grip for the user of the pencil.

U.S. Pat. No. 595,361 (Andrew) teaches and describes a fountain pen having a pair of nibs disposed at one end of a cylindrical barrel with the nibs arranged such that when it is desired to switch from one to the next, the barrel must be rotated 180 degrees.

U.S. Pat. No. 946,036 (Hallock) teaches and describes a fountain pen having a pair of opposed nibs and, in another configuration, a pair of nibs arranged in side-by-side relationship.

U.S. Pat. No. 1,938,835 (Grzyb) teaches and describes a multi-color fountain pen having three nibs in circular fashion at one end of a cylindrical barrel with each nib communicating with an ink reservoir of a different color.

It is an object of the present invention to provide a pen capable of writing in more than one color of ink with an extremely simplified construction.

A further object is to provide such pens in configurations which allow the user to switch simply, quickly and accurately from one color to another using only one hand.

A further object is to provide such pens in forms which provide tactile indexing allowing the user to accurately determine when the pen has been shifted from one color to another.

A further object is to provide such pens in forms which require no mechanical components nor moving parts.

A further object is to provide such pens in forms allowing simple change or replacement of ink refills.

A further object is to provide such pens in forms which are simple and economical to manufacture.

### BRIEF DESCRIPTIONS OF THE INVENTION

The design of the present invention offers significant advantages over the art hereinabove discussed, advantages which may not be fully appreciated until manufacture and use of the present invention is compared to the prior art devices. In particular, a preferred embodiment of the present invention mounts two standard ball point pen refills in a pen body which is generally oblong in cross section, having rounded corners to create a “race track” configuration. The refills are held in parallel relationship one to the other with both tips protruding from the pen body at one end of the body and with the tips spaced far enough apart to enable a user to comfortably write with one tip while the other tip remains well away from contact with the writing surface. When the user wants to switch tips as, for example to write in a different color, the shape of the pen body makes it extremely easy to use one hand to manipulate the pen quickly, accurately and effectively to bring the second writing tip into contact with the writing surface. No mechanisms or moving parts are required to make the transfer between tips possible. Neither tip has to be retracted, moved or adjusted in order to bring the other tip to bear on the writing surface. Because the pen body is oblong in cross-sectional configuration it provides a natural gripping surface, similar to the configuration long used in carpenter's pencils wherein an oblong wooden holder carries a centrally positioned pencil lead.

The pen body can be formed from a number of materials, such as wood or well-known thermoplastics and the simple configuration and lack of moving parts makes the present invention marketable in both disposable and refillable forms. If desired, refills can be inserted at both ends of the pen body, making possible the use of up to four different colors. Pens embodying the present invention can also be made with common pen expedients such as pocket clips and caps.

### BRIEF DESCRIPTION OF THE DRAWINGS

These and further aspects of the present invention will become more apparent upon consideration of the accompanying drawings in which:

FIG. 1 is a reproduction of FIG. 1 from U.S. Pat. No. 5,791,798 showing a piece of prior art in the form of a block holding two pencil points;

FIG. 2 is a first side elevation view of a writing instrument constructed in accordance with the present invention;

FIG. 3 is a second side elevation showing the instrument of FIG. 2 rotated 90 degrees;

FIG. 4 is a sectional view along line 4-4 of FIG. 2;

FIG. 5 is a sectional view of the instrument of FIG. 2; and

FIG. 6 is a perspective view of the instrument of FIG. 2 shown with pen tips mounted at both ends thereof.

### DETAILED DESCRIPTION OF THE DRAWINGS

Referring now to FIG. 1, the numeral 10 indicates generally what appears to be a writing instrument having two pencil points 12 and 14 held in a pair of interconnecting blocks 16 and 18. It appears that points 12 and 14 are centered on each block 16, 18 to form a symmetrical arrangement, bringing points 12 and 14 close together.

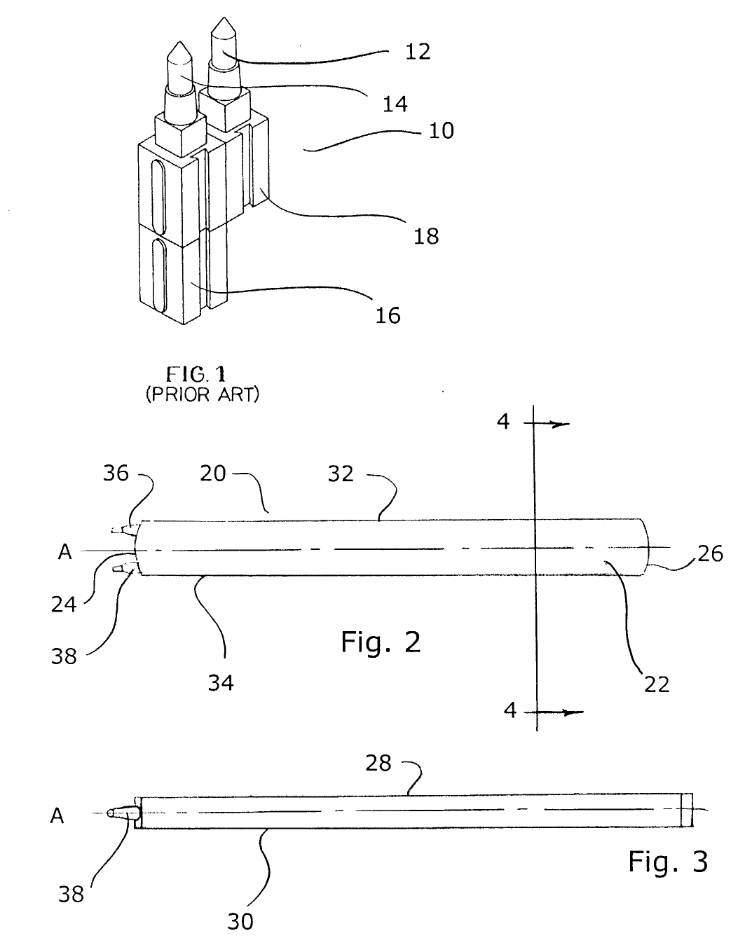

Referring now to FIG. 2, the numeral 20 indicates generally a writing instrument constructed in accordance with a preferred embodiment of the present invention, having a body 22 with a first end 24 and a second end 26.

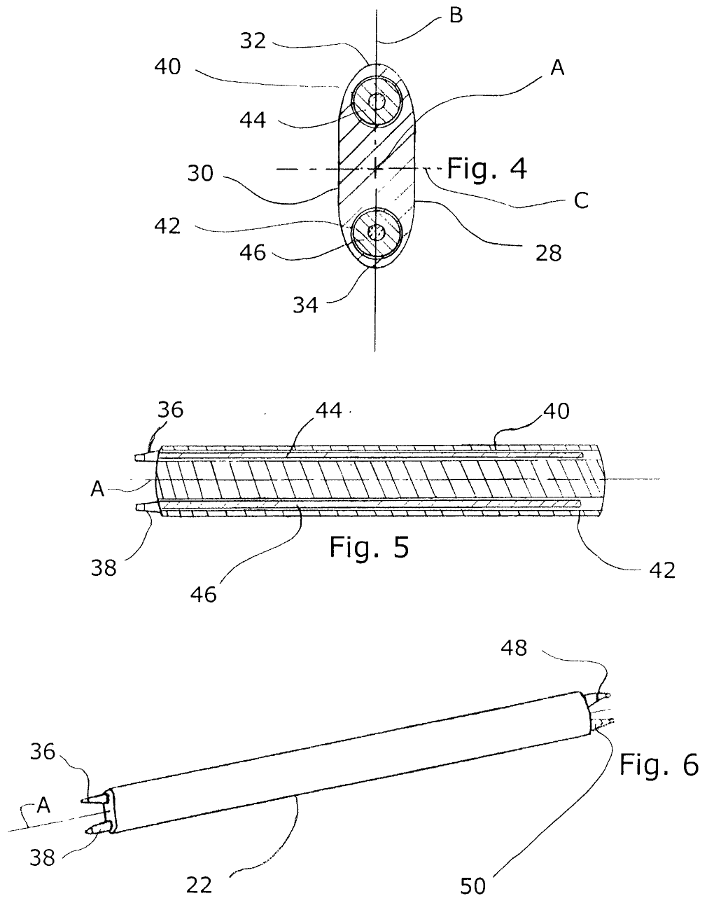

Body 22, preferably formed with a generally flattened profile as can be seen in FIGS. 2 and 3, has a pair of opposed relatively wide sides 28, 30 and a pair of opposed, relatively narrow sides 32, 34. Sides 28, 30 act as grips when the instrument is grasped in a user's hand. Preferably, the configuration of body 22 has a longitudinal axis A extending lengthwise and equidistant between sides 28, 30 and equidistant between sides 32, 34. The cross-sectional configuration of body 22 and positioning of axis A are best shown in FIG. 4 and the cross-sectional shape is best described as oblong or generally or substantially rectangular with rounded edges.

As seen in FIG. 4, body 22 has a major cross-sectional axis B and a minor cross-sectional axis C extending perpendicular to axis A and to each other, with axis B extending along the longest cross-sectional dimension of body 22 and axis C extending along the shortest cross-sectional dimension.

A pair of ball point pen refills 44 and 46 are inserted into body 22 as described below. Refills 44 and 46 have writing tips 36, 38, respectively, which extend from body 22 at end 24. As seen in FIG. 4, refills 44 and 46 and, thereby, tips 36 and 38 preferably are spaced to be closer to sides 32 and 34, respectively, than to axis A. This makes it possible for a user to hold pen 20 comfortably to position tip 36 in contact with a writing surface while keeping tip 38 from making such contact. This also makes it possible for a user accurately to rotate body 22 one-half turn, or 1800, about axis A, to position tip 38 for writing, using only one hand and requiring no moving parts.

The positioning of refills 44 and 46, and tips 36 and 38 in body 22 is best shown in FIGS. 4 and 5 wherein first and second channels 40 and 42 extend parallel one to the other axially along body 22. Each channel 40 and 42 is sized and dimensioned to engage a standard ball point pen refill such as 44 and 46 in a frictional fit, allowing refills 44 and 46 to be pressed into channels 42 and 44 respectively and, if desired, to be pulled out and replaced. Preferably, channels 42 and 44 are parallel to axis A and are centered on axis B proximate sides 32 and 34, positioning tips 36 and 38 relatively far apart, allowing contact of one tip at a time with a writing surface.

Preferably, the color of the ink in refill 44 is different than the color in refill 46.

FIG. 6 shows a perspective view of the writing instrument 20 showing a configuration using four writing tips, with tips 36 and 38 extending from end 24 and tips 48 and 50 extending from end 26. In this configuration, up to four different ink colors can be provided. It is expected that the refills to which tips 36, 38, 48 and 50 are affixed will be foreshortened to allow them to be press-fit into channels 40 and 42.

In use, instrument 20 is gripped along body 22 and it has been found that the size and shape of body 22 allows the user to bring tip 36 in contact with the writing surface while keeping tip 38 a far enough distance away to avoid any accidental contact. When the user finds it necessary to write in a different color ink, body 22 is simply and accurately manipulated, using the writing hand only, to reverse the position of tips 36 and 38 thereby bringing tip 38 into contact with the writing surface.

While the foregoing description has described embodiments in which the refills use ink as a writing medium it is to be understood that refills or inserts using other writing media can be used as well.

The foregoing description has discussed a preferred embodiment in which the disclosed writing instruments are capable of writing with multiple colors. If desired, all refills can be of the same ink color to provide a pen which can be used longer before being required to be refilled.

While the foregoing describes a preferred embodiment or embodiments of the present invention, it is to be understood that this description is made by way of example only and is not intended to limit the scope of the present invention. It is expected that alterations and further modifications, as well as other and further applications of the principles of the present invention will occur to others skilled in the art to which the invention relates and, while differing from the foregoing, remain within the spirit and scope of the invention as herein described and claimed. Where means-plus-function clauses are used in the claims such language is intended to cover the structures described herein as performing the recited functions and not only structural equivalents but equivalent structures as well. For the purposes of the present disclosure, two structures that perform the same function within an environment described above may be equivalent structures.

What is claimed is:

1. A hand-held writing instrument having at least two writing tips, said instrument comprising:
an elongated instrument body,
said body having first and second ends,
said body having a longitudinal, centered first axis extending between said first and second ends,
said body having a generally oblong cross-sectional configuration defining a body periphery with a major axis and a minor axis, said major axis being longer than said minor axis;
at least two writing inserts, each said insert having a writing tip and a supply of writing medium; and
means for mounting said writing inserts in said body to extend at least two said writing tips from one said body end,
said mounting means including first and second mounting channels shaped and dimensioned to receive said inserts,
each said channel extending substantially parallel to said first axis, and
each said channel spaced apart from the remaining said channel along said major axis to a position proximate said body periphery.

2. The apparatus as recited in claim 1 wherein said instrument has two said writing inserts,
both said tips extending from said first end.

3. The apparatus as recited in claim 1 wherein said instrument has four said writing inserts,
two said writing tips extending from said first end and the remaining two said writing tips extending from said second end.

4. The apparatus as recited in claim 2 wherein each said insert has a writing media of a different color.

5. The apparatus as recited in claim 3 wherein selected of said inserts have writing media of different colors.

6. The apparatus as recited in claim 1 wherein said major axis is sufficiently large to index said instrument in a user's hand to positively position one said tip in position to write when said body is rotated 180° about said first axis.

7. The apparatus as recited in claim 1 wherein moving from said first tip to said second tip requires no moving parts.

8. The apparatus as recited in claim 1 wherein said instrument includes means for indexing said instrument into position to use one said tip,
said indexing means comprising dimensioning said major axis sufficiently large to create a pair of opposed, relatively flat portions of said periphery to be gripped by a user's hand.
